(19) United States
(12) Patent Application Publication
(10) Pub. No.: US 2026/0222850 A1
(43) Pub. Date: Jul. 30, 2026

(54) TECHNIQUES FOR INTERLEAVING CONTROL RESOURCES

(71) Applicant: QUALCOMM Incorporated, San Diego, CA (US)

(72) Inventors: Gabi SARKIS, San Diego, CA (US); Diana MAAMARI, San Diego, CA (US); Le LIU, San Jose, CA (US); Mostafa KHOSHNEVISAN, San Diego, CA (US)

(21) Appl. No.: 19/040,418

(22) Filed: Jan. 29, 2025

(51) Int. Cl. H04W 24/08; H04L 1/00; H04W 8/22

(52) U.S. Cl. CPC H04W 24/08; H04L 1/0071; H04W 8/22

(57) ABSTRACT

Various aspects of the present disclosure generally relate to wireless communication. In some aspects, a user equipment (UE) may identify, from a plurality of resource block sets that span a control resource set (CORESET) and that are interleaved within the CORESET, one or more resource block sets that include one or more control channel candidates associated with the UE, wherein each resource block set of the plurality of resource block sets includes a plurality of resource element groups (REGs). The UE may identify a set of frequency resources associated with the one or more resource block sets. The UE may monitor the set of frequency resources for the one or more control channel candidates associated with the UE. Numerous other aspects are described.

### FIELD OF THE DISCLOSURE

Aspects of the present disclosure generally relate to wireless communication and specifically relate to techniques, apparatuses, and methods associated with techniques for interleaving control resources.

### DESCRIPTION OF RELATED ART

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, or radio frequency (RF) sensing, among other examples. As the demand for connectivity continues to increase, further improvements in NR may be implemented, and other RATs, such as 6G and beyond, may be introduced to enable new applications and facilitate new use cases.

In some wireless communication networks, a transmitting wireless communication device (e.g., a network node) may interleave control resources to improve a reliability of the transmissions. For example, a network node may interleave resource element groups (REGs) within a control resource set (CORESET).

### SUMMARY

In some aspects, a method of wireless communication performed by a user equipment (UE) includes identifying, from a plurality of resource block sets that span a control resource set (CORESET) and that are interleaved within the control resource set, one or more resource block sets that include one or more control channel candidates associated with the UE, wherein each resource block set of the plurality of resource block sets includes a plurality of resource element groups (REGs); identifying a set of frequency resources associated with the one or more resource block sets; and monitoring the set of frequency resources for the one or more control channel candidates associated with the UE.

In some aspects, a method of wireless communication performed by a network node includes identifying a plurality of resource block sets that span a CORESET and that are interleaved within the CORESET, wherein each resource block set of the plurality of resource block sets includes a plurality of REGs; mapping one or more control channel candidates to the plurality of resource block sets based at least in part on an interleaving of the plurality of resource block sets within the CORESET; and transmitting the one or more control channel candidates via the CORESET.

In some aspects, a UE includes a processing system that includes one or more processors and one or more code-storing memories coupled with the one or more processors, the processing system configured to cause the UE to: identify, from a plurality of resource block sets that span CORESET and that are interleaved within the control resource set, one or more resource block sets that include one or more control channel candidates associated with the UE, wherein each resource block set of the plurality of resource block sets includes a plurality of REGs; identify a set of frequency resources associated with the one or more resource block sets; and monitor the set of frequency resources for the one or more control channel candidates associated with the UE.

In some aspects, a network node includes a processing system that includes one or more processors and one or more code-storing memories coupled with the one or more processors, the processing system configured to cause the network node to: identify a plurality of resource block sets that span a CORESET and that are interleaved within the CORESET, wherein each resource block set of the plurality of resource block sets includes a plurality of REGs; map one or more control channel candidates to the plurality of resource block sets based at least in part on an interleaving of the plurality of resource block sets within the CORESET; and transmit the one or more control channel candidates via the CORESET.

In some aspects, a non-transitory computer-readable medium storing a set of instructions for wireless communication includes one or more instructions that, when executed by one or more processors of a UE, cause the UE to: identify, from a plurality of resource block sets that span CORESET and that are interleaved within the control resource set, one or more resource block sets that include one or more control channel candidates associated with the UE, wherein each resource block set of the plurality of resource block sets includes a plurality of REGs; identify a set of frequency resources associated with the one or more resource block sets; and monitor the set of frequency resources for the one or more control channel candidates associated with the UE.

In some aspects, a non-transitory computer-readable medium storing a set of instructions for wireless communication includes one or more instructions that, when executed by one or more processors of a network node, cause the network node to: identify a plurality of resource block sets that span a CORESET and that are interleaved within the CORESET, wherein each resource block set of the plurality of resource block sets includes a plurality of REGs; map one or more control channel candidates to the plurality of resource block sets based at least in part on an interleaving of the plurality of resource block sets within the CORESET; and transmit the one or more control channel candidates via the CORESET.

In some aspects, an apparatus for wireless communication includes means for identifying, from a plurality of resource block sets that span CORESET and that are interleaved within the control resource set, one or more resource block sets that include one or more control channel candidates associated with the apparatus, wherein each resource block set of the plurality of resource block sets includes a plurality of REGs; means for identifying a set of frequency resources associated with the one or more resource block sets; and means for monitoring the set of frequency resources for the one or more control channel candidates associated with the apparatus.

In some aspects, an apparatus for wireless communication includes means for identifying a plurality of resource block sets that span a CORESET and that are interleaved within the CORESET, wherein each resource block set of the plurality of resource block sets includes a plurality of REGs; means for mapping one or more control channel candidates to the plurality of resource block sets based at least in part on an interleaving of the plurality of resource block sets within the CORESET; and means for transmitting the one or more control channel candidates via the CORESET.

Aspects of the present disclosure may generally be implemented by or as a method, apparatus, system, computer program product, non-transitory computer-readable medium, user equipment, base station, network node, network entity, wireless communication device, or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network node architecture.

FIG. 3 illustrates an example resource structure for wireless communication.

FIG. 4 is a diagram illustrating an example of interleaving control resources.

FIG. 5 is a diagram illustrating an example associated with interleaving control resources.

FIG. 6 is a diagram illustrating an example process performed, for example, at a UE or an apparatus of a user equipment (UE), in accordance with the present disclosure.

FIG. 7 is a diagram illustrating an example process performed, for example, at a network node or an apparatus of a network node, in accordance with the present disclosure.

FIGS. 8 and 9 are diagrams of example apparatuses for wireless communication.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures or functionalities in addition to or other than the structures or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the application and design constraints imposed on the overall system.

In some wireless communication networks, a transmitting wireless communication device (e.g., a network node) may interleave control resources to improve a reliability of the transmissions. For example, a network node may interleave resource element groups (REGs) within a control resource set (CORESET). Interleaving the control resources may improve the reliability of control channel transmissions (e.g., physical downlink control channel (PDCCH) transmissions) as compared to non-interleaved control channel transmissions. That is, interleaving may increase a frequency diversity of the control channel transmissions. Additionally, mapping adjacent data symbols to non-adjacent REGs increases a likelihood that interference impacts a smaller portion of the control channel transmission as compared to non-interleaved control channel transmissions.

The network node may interleave the REGs by using an interleaved control channel element (CCE)-to-REG mapping for transmissions within a CORESET. In some cases, the interleaving may be based on a set of parameters, such as a number of CCEs within the CORESET, a number of resource elements in the REG, or a number of symbols within the CORESET. In some cases, the network node may be transmitting control channel transmissions to more than one receiving wireless communication device (e.g., a user equipment (UE)). For example, the network node may configure a first UE to monitor a first set of frequency resources (e.g., a first CORESET) to detect or decode a first set of one or more control channel candidates (e.g., a first set of one or more PDCCH candidates). Additionally, the network node may configure a second UE to monitor a second set of frequency resources (e.g., a second CORESET) to detect or decode a second set of one or more control channel candidates (e.g., a second set of one or more PDCCH candidates). If the first and second set of frequency resources overlap (e.g., if the first CORESET associated with the first UE overlaps with the second CORESET associated with the second UE), the control channel transmissions may interfere with one another, resulting in blocking. As one example, the first UE may be a narrowband UE, and may be configured to monitor a small CORESET, and the second UE may be a wideband UE, and may be configured to monitor a large CORESET. If the network node maps the CCEs within the first, small, CORESET using an interleaved CCE-to-REG mapping, the one or more PDCCH candidates for the first UE may potentially collide with multiple PDCCH candidates for the second UE.

To decrease the blocking probability associated with overlapping CORESETs, a network node may restrict interleaving to resources that are within a resource block set. That is, a CORESET may be divided into one or more disjoint subsets that each correspond to a resource block set. Then, the network node may limit the interleaving resources to be within the resource block set. That is, if a UE is configured with a CORESET that is within a single resource block set, the network node may limit the mapping of the CCEs associated with the CORESET to the resources within the single resource block. As a result, if a first CORESET for a first UE overlaps with a second CORESET for a second UE, the potential blocking associated with that overlap may be limited to the resource sets within each CORESET that overlap. In some cases, this may reduce a blocking probability resulting from CORESETs that at least partially overlap.

But limiting the interleaving of resources to be within a resource block set may decrease a reliability of the control channel transmissions. That is, if a UE is configured with a CORESET that spans multiple resource block sets, the interleaving that is limited to interleaving resources within a single resource block set may result in control channel transmissions that have less frequency diversity as compared to interleaving that is not limited to interleaving resources within the single resource block set.

Various aspects relate generally to interleaving the resource block sets within a CORESET. That is, the network node may map the one or more control channel candidates (e.g., PDCCH candidates) associated with a CORESET to resources associated with the CORESET such that the resource block sets within the CORESET are interleaved, but there is no interleaving between resources from different resource block sets (e.g., the CCEs associated with different resource block sets are not interleaved, the bits or symbols associated different resource block sets are not interleaved, the resource blocks or REGs associated with different resource block sets are not interleaved). Accordingly, frequency diversity associated with control channel transmissions that span multiple resource block sets may be achieved, but the blocking of CORESETs that at least partially overlap in frequency may still be limited to the one or more resource block sets within each CORESET that overlap (e.g., instead of the entire CORESETs).

Particular aspects of the subject matter described in this disclosure can be implemented to realize one or more of the following potential advantages. In some examples, the described techniques can be used to improve a reliability of control channel transmissions. That is, the interleaving techniques described herein may enable control channel transmissions to have frequency diversity while decreasing a blocking probability associated with overlapping CORESETs, which may improve a reliability of the control channel transmissions. Additionally, the described techniques can also be used to decrease a power consumption of narrowband UEs. That is, a narrowband UE may be configured with a CORESET that only spans a single resource block set (or spans fewer resource block sets than a UE that is not a narrowband UE). Based on not interleaving resources associated with different resource block sets, the narrowband UE may only monitor a single resource block set to detect or decode the one or more control channel candidates for that UE (e.g., as opposed to monitoring more frequency resources in cases that the resources associated with different resource sets are interleaved).

As described above, wireless communication systems may be deployed to provide various services, which may involve carrying or supporting voice, text, other messaging, video, data, or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies or support one or more of the foregoing use cases or new use cases.

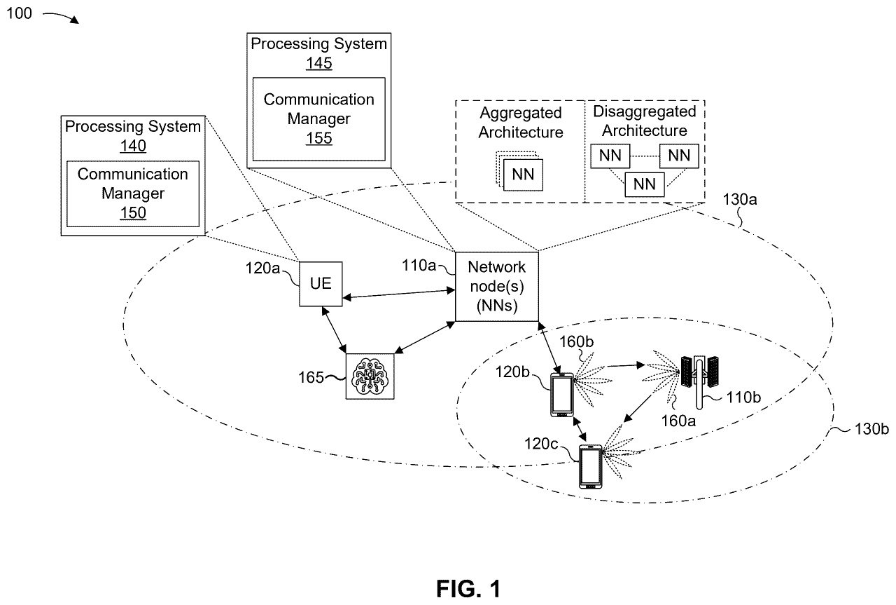

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless communication networks 100 may be deployed in a given geographic area. Each wireless communication network 100 may support a RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, or that are included in mid-band frequencies. Similarly, the term “millimeter wave,” if used herein, may broadly refer to mid-band frequencies or to frequencies that are within FR2, FR4, FR4-a or FR4-1, FR5, or the EHF band. Higher frequency bands may extend 5G NR operation, 6G operation, or other RATs beyond 52.6 GHz.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 or the processing system 145 include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 of the UE 120 or by the processing system 145 of the network node 110).

A processing system (e.g., the processing system 140 or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also may output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

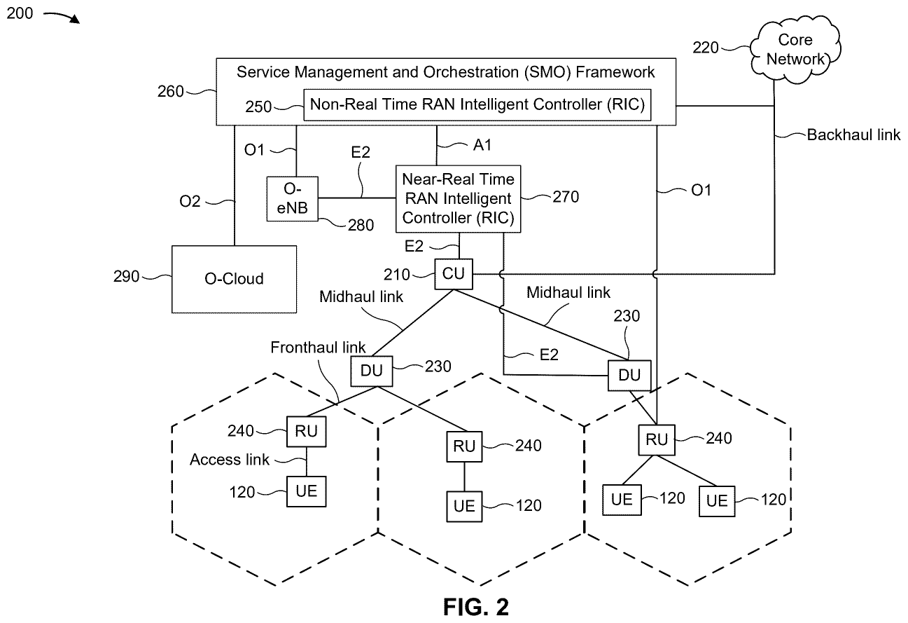

Alternatively, and as also shown, a network node 110 may be a disaggregated network node (sometimes referred to as a disaggregated base station), having a disaggregated architecture, meaning that the network node 110 may operate with a radio protocol stack that is physically distributed or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, or disaggregated network nodes, among other examples. Various different types of network nodes 110 may generally transmit at different power levels, serve different coverage areas (for example, a cell 130a and a cell 130b), or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, or any other suitable device or function that may communicate via a wireless medium.

Some UEs 120 may be classified according to different categories in association with different complexities or different capabilities. UEs 120 in a first category may facilitate massive IoT in the wireless communication network 100, and may offer low complexity or cost relative to UEs 120 in a second category. UEs 120 in a second category may include mission-critical IoT devices, legacy UEs, baseline UEs, high-tier UEs, advanced UEs, full-capability UEs, or premium UEs that are capable of URLLC, eMBB, or precise positioning in the wireless communication network 100, among other examples. A third category of UEs 120 may have mid-tier complexity or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, or an NR-Lite UE, among other examples. RedCap UEs may bridge a gap between the capability and complexity of NB-IoT devices or eMTC UEs, and mission-critical IoT devices or premium UEs. RedCap UEs may include, for example, wearable devices, IoT devices, industrial sensors, or cameras that are associated with a limited bandwidth, power capacity, or transmission range, among other examples. In some cases, RedCap UEs that are associated with limited bandwidth may be narrowband UEs based on a capability of the UE. RedCap UEs may support healthcare environments, building automation, electrical distribution, process automation, transport and logistics, or smart city deployments, among other examples. In some cases, RedCap UEs may not be capable of communicating on as wide of a maximum bandwidth (BWP) as a UE 120 in the second category.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, transmit directions or beams).

Frequency domain resources may be subdivided into BWPs. A BWP may be a block of frequency domain resources (for example, a continuous set of resource blocks within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the number of frequency domain resources that a UE 120 is required to monitor and reduce UE power consumption by enabling the UE to monitor fewer frequency domain resources), leaving more frequency domain resources to be spread across multiple UEs 120. In some cases, UEs 120 that are configured to monitor fewer frequency domain resources to reduce the UE power consumption may be narrowband UEs 120 based on an implementation of the UE 120. Thus, BWPs may also assist in the implementation of lower-capability (for example, RedCap) UEs 120 by facilitating the configuration of smaller bandwidths for communication by such UEs 120 or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify resource blocks in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 or UE 120 may communicate using massive MIMO, multi-user MIMO, or single-user MIMO, which may involve rapid switching between beams or cells. For example, the amplitudes or phases of signals transmitted via antenna elements or sub-elements may be modulated and shifted relative to each other (such as by manipulating a phase shift, a phase offset, or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, or a vertical direction), a set of parameters that indicate one or more aspects of a directional signal, a direction associated with the signal, or a set of directional resources associated with the signal, among other examples.

MIMO may be implemented using various spatial processing or spatial multiplexing operations. In some examples, MIMO may include a massive MIMO technique which may be associated with an increased (for example, “massive”) number of antennas at the network node 110 or at the UE 120, such as in a network implementing mmWave technology. Massive MIMO may improve communication reliability by enabling a network node 110 or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state or a quasi-co-location (QCL) parameter, among other examples. The network node 110 and the UE 120 may increase reliability or achieve efficiencies in throughput, signal strength, or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, or one or more servers, or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases such as beam management, radio resource monitoring (RRM) relaxation, mobility prediction, load prediction, network energy savings, or coverage and capacity improvements, among other examples.

As indicated above, a BWP may be configured as a subset or a part of a total or full component carrier bandwidth and generally forms or encompasses a set of contiguous resource blocks within the full component carrier bandwidth. In other words, within the carrier bandwidth, a BWP starts at a specifically configured resource block and may span a specific set of consecutive resource blocks. Each BWP may be associated with its own numerology (indicating a sub-carrier spacing (SCS) and cyclic prefix (CP)). A UE 120 may be configured with up to four downlink BWPs and up to four uplink BWPs for each serving cell. To reduce UE power consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications.

In some examples, a UE 120 or network node 110 may implement power saving features (also referred to as energy saving features). Power saving features may include, for example, relaxed radio resource monitoring (such as relaxed reference signal monitoring for devices operating in low mobility or in good radio conditions), discontinuous reception (DRX) operation, reduced PDCCH monitoring during DRX active times, on-demand system information transmission, on-demand synchronization signal block (SSB) transmission, antenna port adaptation, advanced channel state information (CSI) reporting, or power-efficient paging reception.

In some aspects, the UE 120 may include a communication manager 150. As described in more detail elsewhere herein, the communication manager 150 may identify, from a plurality of resource block sets that span CORESET and that are interleaved within the control resource set, one or more resource block sets that include one or more control channel candidates associated with the UE, wherein each resource block set of the plurality of resource block sets includes a plurality of REGs; identify a set of frequency resources associated with the one or more resource block sets; and monitor the set of frequency resources for the one or more control channel candidates associated with the UE. Additionally, or alternatively, the communication manager 150 may perform one or more other operations described herein.

In some aspects, the network node 110 may include a communication manager 155. As described in more detail elsewhere herein, the communication manager 155 may identify a plurality of resource block sets that span a CORESET and that are interleaved within the CORESET, wherein each resource block set of the plurality of resource block sets includes a plurality of REGs; map one or more control channel candidates to the plurality of resource block sets based at least in part on an interleaving of the plurality of resource block sets within the CORESET; and transmit the one or more control channel candidates via the CORESET. Additionally, or alternatively, the communication manager 155 may perform one or more other operations described herein.

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

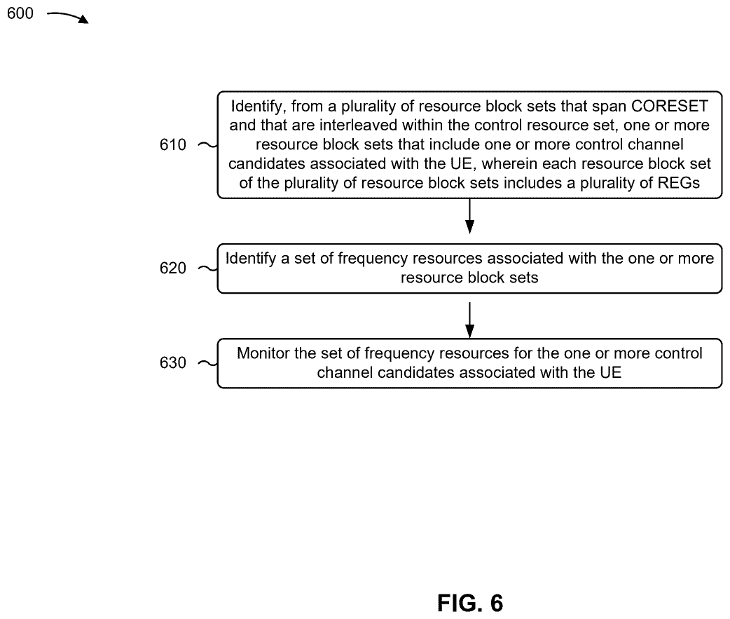

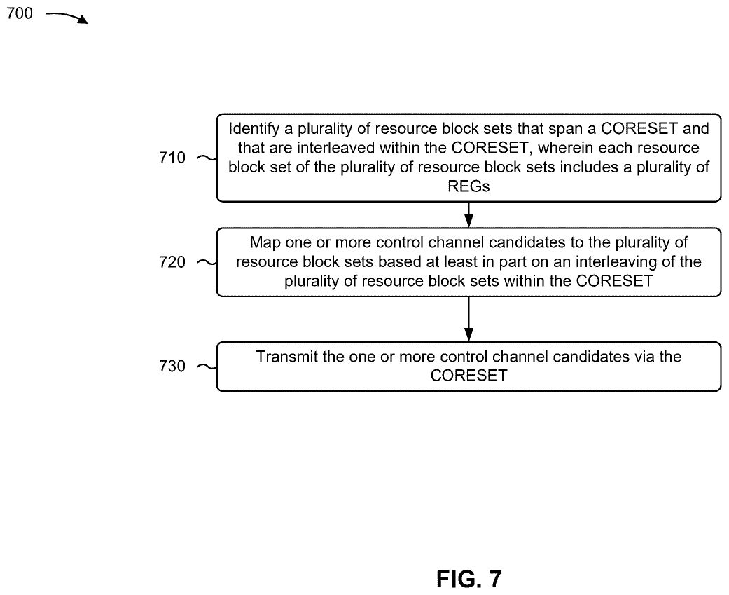

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with interleaving control resources, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

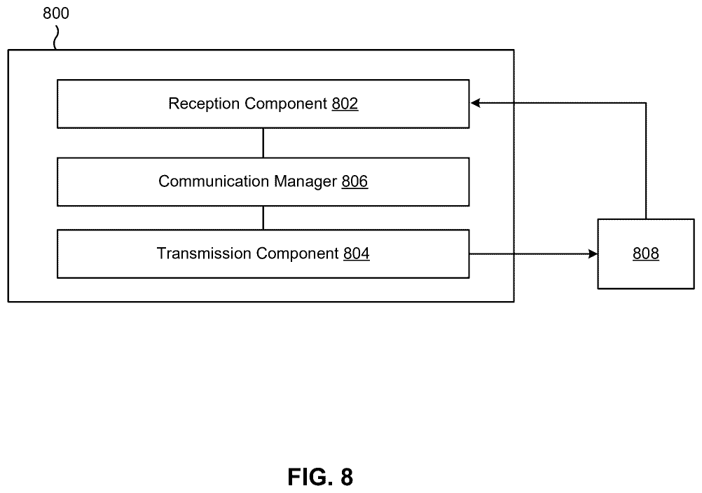

In some aspects, the UE includes means for identifying, from a plurality of resource block sets that span CORESET and that are interleaved within the control resource set, one or more resource block sets that include one or more control channel candidates associated with the UE, wherein each resource block set of the plurality of resource block sets includes a plurality of REGs; means for identifying a set of frequency resources associated with the one or more resource block sets; or means for monitoring the set of frequency resources for the one or more control channel candidates associated with the UE. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

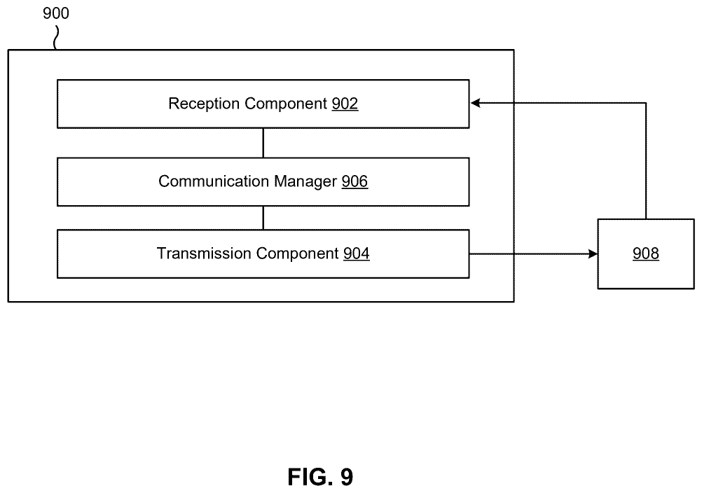

In some aspects, the network node includes means for identifying a plurality of resource block sets that span a CORESET and that are interleaved within the CORESET, wherein each resource block set of the plurality of resource block sets includes a plurality of REGs; means for mapping one or more control channel candidates to the plurality of resource block sets based at least in part on an interleaving of the plurality of resource block sets within the CORESET; or means for transmitting the one or more control channel candidates via the CORESET. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

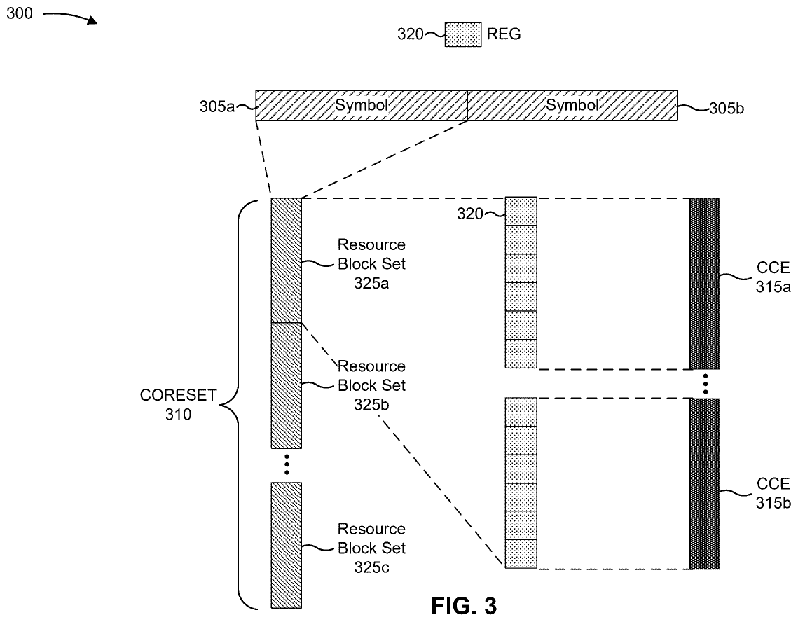

FIG. 3 illustrates an example resource structure 300 for wireless communication. Resource structure 300 shows an example of various sets of resources described herein. As shown, resource structure 300 may include two symbols: symbol 305a and symbol 305b.

A region within the resource structure 300 that is configured to carry control channel transmissions may be referred to as a CORESET 310, and may be structured to support an efficient use of resources, such as by flexible configuration or reconfiguration of resources of the CORESET 310 for one or more control channel transmissions, such as PDCCHs. The CORESET 310 may correspond to a CORESET 0 or a CORESET other than CORESET 0.

In some aspects, the CORESET 310 may occupy one symbol 305a. In some other aspects, the CORESET 310 may occupy more than one symbol 305 (e.g., may occupy both the symbol 305a and the symbol 305b, may occupy three symbols 305). Thus, a CORESET 310 may include multiple resource blocks in the frequency domain, and either one, two, or three symbols 305 in the time domain. A number of resources included in the CORESET 310 may be flexibly configured, such as by using RRC signaling to indicate a frequency domain region (e.g., a number of resource blocks) or a time domain region (e.g., a number of symbols 305) for the CORESET 310.

As illustrated, a symbol 305a that includes CORESET 310 may include one or more CCEs 315, such as the CCE 315a and the CCE 315b, that span a portion of the system bandwidth. A CCE 315 may include DCI that is used to provide control information for wireless communication. A network node may transmit DCI during multiple CCEs 315 via one or more control channel candidates (such as via one or more PDCCH candidates). A possible location (e.g., in time or frequency) for a control channel transmission may be referred to as a control channel candidate. For example, a possible location for a PDCCH transmission may be referred to as a PDCCH candidate). The number of CCEs 315 used for transmission of DCI represents the aggregation level used by the network node for the transmission of DCI. For example, if two CCEs 315a and 315b are used for transmission of DCI, the DCI may correspond to an aggregation level of 2. In some aspects, different aggregation levels may be used, such as 1, 4, 8, 16, or the like.

Each CCE 315 may include a fixed number of REGs 320, shown as 6 REGs 320, or may include a variable number of REGs 320. In some aspects, the number of REGs 320 included in a CCE 315 may be specified by an REG bundle size. An REG 320 may include one resource block, which may include 12 resource elements (REs) within a symbol 305. A resource element may occupy one subcarrier in the frequency domain and one OFDM symbol in the time domain.

A CORESET 310 may include one or more search spaces, such as a UE-specific search space, a group-common search space, or a common search space. A search space may indicate a set of CCEs 315 for a UE to monitor to attempt to detect and decode one or more PDCCH candidates. The possible locations for a PDCCH candidate may depend on whether the PDCCH is a UE-specific PDCCH (e.g., for a single UE) or a group-common PDCCH (e.g., for multiple UEs), an aggregation level being used, or the like. The set of all PDCCH candidates may be referred to as a search space. For example, the set of all possible PDCCH candidates for a UE may be referred to as a UE-specific search space. Similarly, the set of all possible PDCCH candidates across all UEs may be referred to as a common search space. Similarly, the set of all possible PDCCH candidates for a group of UEs may be referred to as a group-common search space.

In some wireless communication networks, a network node may interleave control resources to improve a reliability of the transmissions. For example, the network node may interleave REGs 320 within the CORESET 310. Additionally, or alternatively, the network node may interleave REG bundles, where each REG bundle includes one or more REGs 320. For example, an REG bundle may include one REG 320, 3 REGs 320, or 6 REGs 320. The network node may interleave the REGs 320 (or REG bundles) by using an interleaved CCE-to-REG mapping for transmissions within the CORESET 310. In some cases, the interleaving may be based on a set of parameters, such as a number of CCEs 315 within the CORESET 310, a number of resource elements in the REG 320, or a number of symbols 305 within the CORESET 310. In some cases, the network node may be transmitting control channel transmissions to more than one UE. For example, the network node may configure a first UE to monitor a first CORESET 310 and a second UE to monitor a second CORESET 310. If the first and second CORESETs 310 overlap, the control channel transmissions may interfere with one another, resulting in blocking.

To decrease the blocking probability associated with overlapping CORESETs, a network node may restrict interleaving to resources that are within a resource block set 325. That is, a CORESET 310 may be divided into one or more disjoint subsets that each correspond to a resource block set 325. For example, the CORESET 310 may be divided into three resource block sets 325. Here, if the CORESET 310 spans 90 MHz, the CORESET 310 may be divided into three resource block sets 325 that each span 30 MHz. Each resource block set 325 may include a plurality of resource blocks (e.g., a plurality of REGs 320, where each REG 320 corresponds to one resource block). Additionally, or alternatively, each resource block set 325 may include more than one REG bundle. The resource block sets 325 may also be referred to as sub-CORESETs or CORESET segments.

The network node may transmit signaling (e.g., RRC signaling) configuring the CORESET 310. The signaling may indicate the set of resource block sets 325 within the CORESET 310. For example, the signaling may indicate a number of resource block sets 325 in the CORESET 310, a bandwidth associated with each resource block set 325 in the CORESET 310, a number of REGs 320 or REG bundles within each resource block set 325, or some other parameters related to the resource block sets 325 in the CORESET 310.

The network node may interleave the resources within each resource block set 325. For example, the network node may interleave the REGs 320 within the resource block set 325a, interleave the REGs 320 within the resource block set 325b, and interleave the REGs 320 within the resource block set 325c. Here, if a UE is configured with a CORESET 310 that is within a single resource block set 325, the network node may limit the mapping of the CCEs 315 associated with the CORESET 310 to the resources within the single resource block set 325. As a result, if a first CORESET 310 for a first UE overlaps with a second CORESET 310 for a second UE, the potential blocking associated with that overlap may be limited to the resource sets 325 within each CORESET 310 that overlap. In some cases, this may reduce a blocking probability resulting from CORESETs 310 that at least partially overlap.

But limiting the interleaving of resources to be within a resource block set 325 may decrease a reliability of the control channel transmissions. That is, if a UE is configured with a CORESET 310 that spans multiple resource block sets 325, interleaving that is limited to interleaving resources within a single resource block set 325 may result in control channel transmissions that have less frequency diversity as compared to interleaving that is not limited to interleaving resources within the single resource block set 325.

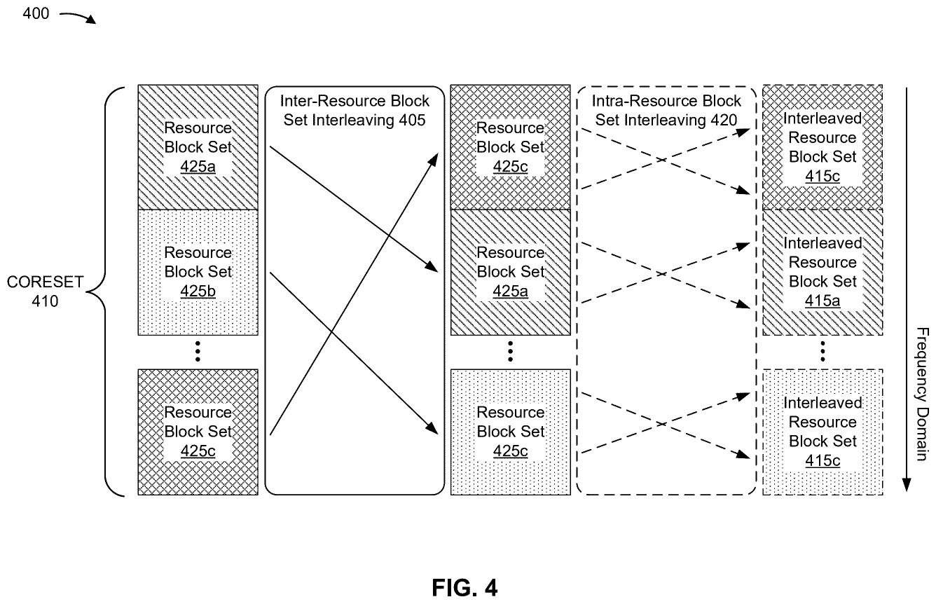

In the example resource structure 300, the resource block sets 325 within a CORESET 310 may be interleaved. That is, the network node may map the one or more PDCCH candidates associated with the CORESET 310 to resources associated with the CORESET 310 such that the resource block sets 325 within the CORESET 310 are interleaved, but there is no interleaving between resources from different resource block sets 325 (e.g., the CCEs 315 associated with different resource block sets 325 are not interleaved, the bits or symbols associated with different resource block sets 325 are not interleaved, the resource blocks or REGs 320 associated with different resource block sets 325 are not interleaved). In some cases, the network node may both interleave the resources within a resource block set 325 and interleave the resource block sets 325. For example, the network node may interleave the REGs 320 (or REG bundles) within each resource block set 325. Additionally, the network node may interleave the resource block sets 325 within the CORESET 310. An example of the interleaving of the resource blocks 325 within a CORESET 310 is illustrated and described with reference to FIG. 4.

As indicated above, FIG. 3 is provided as an example. Other examples may differ from what is described with regard to FIG. 3.

FIG. 4 is a diagram illustrating an example 400 of interleaving control resources. The example 400 illustrates interleaving of resources associated with a CORESET 410. The CORESET 410 may include aspects of the CORESET 310 described with reference to FIG. 3. For example, the CORESET 410 may be divided into a plurality of resource block sets 425, which may be examples of the resource block sets 325 described with reference to FIG. 3.

The CORESET 410 may correspond to a CORESET 0 or a CORESET other than CORESET 0. The CORESET 410 may include the plurality of resource block sets 425 that span the CORESET 410. In some cases, each of the resource block sets 425 within the CORESET 410 may be nonoverlapping (e.g., disjoint) and may include a plurality of resource blocks. Additionally, each resource block set 425 may include more than one REG bundle (where each REG bundle includes 1, 3, or 6 REGs).

A PDCCH transmission may be fully contained within a single resource block set 425. For example, a PDCCH transmission for a UE that is configured to monitor a narrowband of frequency resources (e.g., a narrowband UE) may be fully contained within a single resource block set 425. That is, a single resource block set 425 may include one or more of the PDCCH candidates associated with the PDCCH transmission (e.g., in accordance with the aggregation level of the PDCCH transmission). Additionally, a PDCCH transmission may span more than one resource block set 425. For example, a PDCCH transmission for a UE that is configured to monitor a wideband of frequency resources (e.g., a wideband UE) may span more than one resource block set 425. That is, more than resource block set 425 (e.g., the resource block set 425a and the resource block set 425b) may include one or more of the PDCCH candidates associated with the PDCCH transmission (e.g., in accordance with the aggregation level of the PDCCH transmission). In some cases, PDCCH transmissions associated with larger aggregation levels may be more likely to span more than one resource block sets 425.

A network node (or any other wireless communication device that is transmitting the one or more PDCCH transmissions within the CORESET 410) may perform an inter-resource block set interleaving 405 to obtain a CORESET 410 that includes a plurality of resource block sets 425 that are interleaved. After the inter-resource block set interleaving 405, the resource block sets 425 may not be sequentially ordered within the CORESET 410 (e.g., based on an index associated with each resource block set 425). That is, prior to the inter-resource block set interleaving 405, the resource block sets 425 may be ordered within the frequency domain sequentially. That is, a first resource block set 425a associated with a smallest index (e.g. ‘0’) may include a subset of frequencies in the CORESET 410 that correspond to the smallest frequencies of the CORESET 410, a second resource block set 425b associated with a next-smallest index (e.g., ‘1’) may include a subset of frequencies in the CORESET 410 that correspond to the next-smallest frequencies of the CORESET 410, and a last resource block set 425c associated with a largest index may include a subset of frequencies in the CORESET 410 that correspond to the largest frequencies of the CORESET 410.

In one example, the CORESET 410 includes a first resource block set 425a associated with a first index value (e.g. ‘0’), a second resource block set 425b associated with a second index value (e.g. ‘1’), and a third resource block set 425c associated with a third index value (e.g., ‘2’). Here, after the inter-resource block set interleaving 405, the third resource block set 425c may be mapped to the subset of frequencies in the CORESET 410 that includes the smallest frequencies within the CORESET 410, the first resource block set 425a may be mapped to the subset of frequencies in the CORESET 410 that includes the middle frequencies within the CORESET 410, and the second resource block set may be mapped to the subset of frequencies of the CORESET 410 that includes the largest frequencies within the CORESET 410.

The inter-resource block set interleaving 405 may correspond to an equation (e.g., that is predefined or preconfigured) or a mapping that is configured by the network node. If the inter-resource block set interleaving 405 corresponds to an equation, the equation may correspond to a geometric structure (e.g., a row-column interleaver), where the equation utilizes the geometric structure and includes one or more configurable parameters (e.g., the size of the row, the size of the column). In another example where the inter-resource block set interleaving 405 corresponds to an equation, the equation may not be based on a geometric structure. Here, the equation may be predefined and known to both the network node and a receiving wireless communication device.

Additionally, if the inter-resource block set interleaving 405 corresponds to a mapping, the network node may indicate the mapping of each resource block set 425 within the CORESET 410. For example, the network node may indicate a mapping of each virtual resource block set (e.g., corresponding to the resource block sets 425 prior to the inter-resource block set interleaving 405) to a physical resource block set (e.g., corresponding to the resource block sets 425 after the inter-resource block set interleaving 405). In some cases, the network node may indicate the mapping by indicating, for each virtual resource block set, a starting CCE or a starting resource block for the corresponding physical resource block set.

While the example 400 illustrates inter-resource block set interleaving 405 that occurs at a resource block set 425 granularity, the network node may interleave the resource block sets 425 according to a different granularity. That is, to perform the inter-resource block set interleaving 405, the network node may interleave groups of resource block sets 425. For example, the network node may interleave groups of resource block sets 425 that include 2, 3, or more than 3 resource block sets 425. In one example, the network node may interleave groups of two resource block sets 425 within the CORESET 410. Here, the resource block set 425a and the resource block set 425b may be interleaved with one or more other groups of two resource block sets 425 within the CORESET 410. In some cases, a network node may configure the granularity of interleaving for the inter-resource block set interleaving 405. For example, the network node may configure a group size for the inter-resource block set interleaving 405 (e.g., corresponding to the number of resource block sets 425 within each group).

In some cases, the network node (or any other wireless communication device transmitting a PDCCH transmission within the CORESET 410) may also perform an intra-resource block set interleaving 420 to obtain a CORESET 410 that includes a plurality of interleaved resource block sets 415. For example, the network node may interleave the resources within each resource block set 425 to obtain the interleaved resource block set 415. As part of the intra-resource block set interleaving 420, the network node may interleave the resources within each resource block set 425 according to an REG granularity (e.g., a resource block granularity), an REG bundle granularity, or some other granularity. In some cases, a network node may configure the granularity of interleaving for the intra-resource block set interleaving 420 (e.g., via a configuration for a PDCCH transmission, via a configuration for the CORESET 410).

If the network node performs both the inter-resource block set interleaving 405 and the intra-resource block set interleaving 420, the network node may perform the inter-resource block set interleaving 405 prior to performing the intra-resource block set interleaving 420. That is, the network node may interleave the resources within each resource block set 425 after interleaving the resource block sets 425 within the CORESET 410. Additionally, or alternatively, the network node may perform the intra-resource block set interleaving 420 prior to performing the inter-resource block set interleaving 405. That is, the network node may interleave the resources within each resource block set 415 prior to interleaving the interleaved resource block sets 415 within the CORESET 410.

As indicated above, FIG. 4 is provided as an example. Other examples may differ from what is described with respect to FIG. 4.

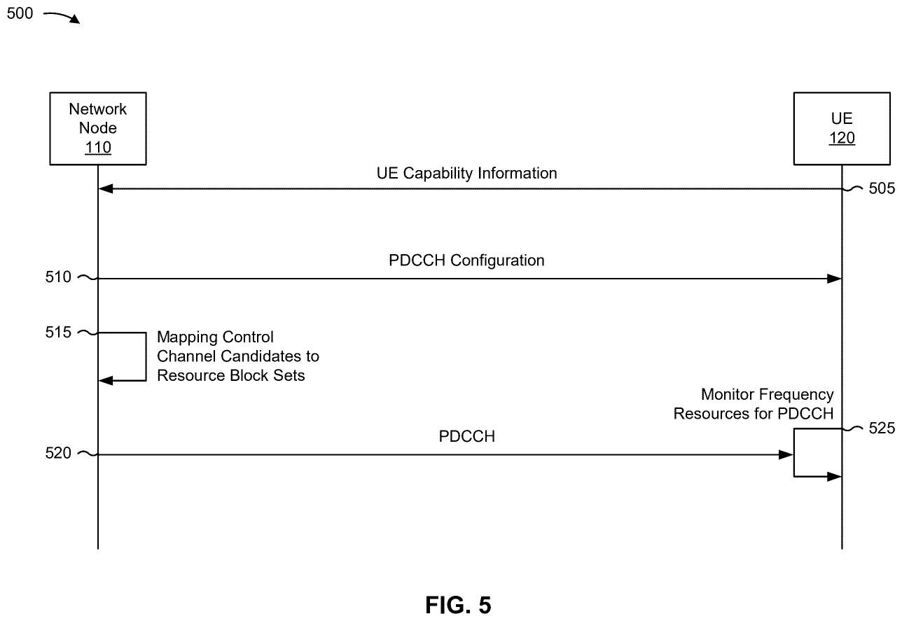

FIG. 5 is a diagram illustrating an example 500 associated with interleaving control resources. As shown in FIG. 5, a network node 110 and a UE 120 may communicate with one another. That is, the network node 110 may interleave control resources, and transmit the interleaved control resources to the UE 120. The interleaving of the control resources described with reference to FIG. 5 may include aspects of the inter-resource block set interleaving and the intra-resource block set interleaving described with reference to FIG. 4.

At 505, the UE 120 may transmit, and the network node 110 may receive, signaling indicating UE capability information. The signaling may indicate a bandwidth that the UE 120 is capable of monitoring (e.g., for PDCCH transmissions). The bandwidth that the UE 120 is capable of monitoring may correspond to a bandwidth capability of the UE 120. The UE 120 may indicate the bandwidth that the UE 120 is capable of monitoring according to a granularity of a resource block set. For example, the signaling may include an indication of a number of resource block sets, and the bandwidth that the UE 120 is capable of monitoring may correspond to the indicated number of resource block sets.

At 510, the network node 110 may transmit, and the UE 120 may receive, signaling indicating a PDCCH configuration. In some cases, the signaling indicating the PDCCH configuration may indicate an aggregation level associated with a PDCCH transmission and a set of resources associated with the PDCCH transmission. For example, the signaling may indicate a bandwidth (e.g., a set of frequency resources) for the UE 120 to monitor to detect or decode the PDCCH transmission. In some cases, to indicate the bandwidth for the UE 120 to monitor, the signaling may include one or more indices corresponding to one or more resource block sets within the CORESET. For example, if the UE 120 is a narrowband UE and is configured to monitor a single resource block set, the signaling may include a single index corresponding to the single resource block set for the UE 120 to monitor. In another example, if the UE 120 is a narrowband UE and is configured to monitor multiple resource block sets, the signaling may include multiple indices corresponding to each of the multiple resource block sets.

The network node 110 may also transmit signaling to indicate an interleaving configuration for the PDCCH transmission. In some aspects, the signaling indicating the interleaving configuration for the PDCCH transmission may be included in the signaling indicating the PDCCH configuration.

In some other aspects, the signaling indicating the interleaving configuration may correspond to signaling configuring one or more other parameters associated with communications between the network node 110 and the UE 120. In some cases, the interleaving configuration associated with the PDCCH transmission may be based on a configuration of the CORESET associated with the PDCCH transmission. For example, the network node 110 may configure the interleaving configuration for PDCCH transmissions within the CORESET via the configuration of the CORESET.

In some other cases, the interleaving configuration associated with the PDCCH transmission may be based on a type of the CORESET associated with the PDCCH transmission. For example, the network node 110 may configure the interleaving configuration for PDCCH transmissions with CORESETs based on the type of the CORESET (e.g., for CORESET 0, for CORESETs that are not CORESET 0). In some other cases, the interleaving configuration associated with the PDCCH transmission may be based on an aggregation level of the PDCCH transmission. For example, the network node 110 may configure intra-resource block set interleaving for PDCCH transmissions associated with aggregation levels that are less than a threshold (e.g., for PDCCH transmissions having an aggregation level of 1 or 2).

In some other cases, the interleaving configuration associated with the PDCCH transmission may be based on the frequency resources associated with the CORESET. For example, if the CORESET includes more than a threshold number of frequency resources (e.g., a threshold number of resource blocks, a threshold number of CCEs), the interleaving configuration may indicate that the PDCCH transmission is associated with inter-resource block set interleaving.

The interleaving configuration associated with the PDCCH transmission may be indicative of whether the PDCCH transmission corresponds to an interleaved or a non-interleaved transmission. If the PDCCH transmission corresponds to an interleaved transmission, the interleaving configuration may additionally indicate whether the PDCCH transmission includes resource block sets that are interleaved (e.g., whether the PDCCH transmission is associated with inter-resource block set interleaving), whether the PDCCH transmission includes resource block sets that include resources that are interleaved within the resource block set (e.g., whether the PDCCH transmission is associated with intra-resource block set interleaving), or both.

The interleaving configuration may also indicate a resource block set granularity for inter-resource block set interleaving within the CORESET. Additionally, the signaling may optionally indicate a mapping for the inter-resource block interleaving of each resource block set 425 within the CORESET 410. For example, the network node may indicate a mapping of each virtual resource block set (e.g., corresponding to the resource block sets prior to the inter-resource block set interleaving) to a physical resource block set (e.g., corresponding to the resource block sets after the inter-resource block set interleaving). The signaling may not indicate the mapping if the inter-resource block set interleaving is indicated by an equation (e.g., that is predefined or preconfigured).

At 515, the network node 110 may map one or more control channel candidates to resource block sets. The network node 110 may map the one or more control channel candidates (e.g., the one or more PDCCH candidates) to the resource block sets according to the interleaving configuration associated with the PDCCH transmission. For example, if inter-resource block set interleaving is configured for the PDCCH transmission, the network node 110 may interleave the plurality of resource block sets within the CORESET. Here, the CORESET may include the plurality of resource block sets that are interleaved. Additionally, if intra-resource block set interleaving is configured, the network node 110 may interleave the REGs within each resource block set to map the control channel candidates to the resource block sets. Here, the set of REGs within each resource block set may be interleaved. In some cases, intra-resource block set interleaving may not be configured and the network node 110 may not interleave the REGs within each resource block set. Here, the set of REGs within each resource block set may be non-interleaved.

At 520, the network node 110 may transmit, to the UE 120, a PDCCH transmission.

At 525, the UE 120 may monitor a set of frequency resources for the PDCCH transmission. That is, the UE 120 may identify one or more resource block sets within the CORESET that include one or more control channel candidates (e.g., PDCCH candidates) for the UE 120. In some cases, the UE 120 may identify the one or more resource block sets based on a configuration of the CORESET or a configuration associated with the PDCCH transmission. The UE 120 may then identify the set of frequency resources associated with the one or more resource block sets. The UE 120 may identify the set of frequency resources based on the inter-resource block set interleaving associated with the PDCCH transmission. The UE 120 may then monitor the identified set of frequency resources.

In some cases, a subset of the resource block sets within the CORESET may include control channel candidates for the UE 120. That is, one or more resource block sets within the CORESET may not include control channel candidates for the UE 120. Here, the UE 120 may refrain from monitoring the one or more resource block sets within the CORESET that do not include control channel candidates for the UE 120. That is, the UE 120 may monitor a subset of the CORESET and may not monitor the frequency resources associated with the entire CORESET when one or more of the resource block sets within the CORESET do not include control channel candidates for the UE 120.

Based on monitoring the set of frequency resources, the UE 120 may attempt to detect and decode the one or more control channel candidates (e.g., the one or more PDCCH candidates). The UE 120 may attempt to decode the one or more control channel candidates based on an intra-resource block set interleaving configuration associated with the PDCCH transmission (e.g., based on whether the resources within the one or more resource block sets are interleaved or not).

As indicated above, FIG. 5 is provided as an example. Other examples may differ from what is described with respect to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with interleaving control resources.

As shown in FIG. 6, in some aspects, process 600 may include identifying, from a plurality of resource block sets that span CORESET and that are interleaved within the control resource set, one or more resource block sets that include one or more control channel candidates associated with the UE, wherein each resource block set of the plurality of resource block sets includes a plurality of REGs (block 610). For example, the UE (e.g., using communication manager 806, depicted in FIG. 8) may identify, from a plurality of resource block sets that span CORESET and that are interleaved within the control resource set, one or more resource block sets that include one or more control channel candidates associated with the UE, wherein each resource block set of the plurality of resource block sets includes a plurality of REGs, as described above.

As further shown in FIG. 6, in some aspects, process 600 may include identifying a set of frequency resources associated with the one or more resource block sets (block 620). For example, the UE (e.g., using communication manager 806, depicted in FIG. 8) may identify a set of frequency resources associated with the one or more resource block sets, as described above.

As further shown in FIG. 6, in some aspects, process 600 may include monitoring the set of frequency resources for the one or more control channel candidates associated with the UE (block 630). For example, the UE (e.g., using communication manager 806, depicted in FIG. 8) may monitor the set of frequency resources for the one or more control channel candidates associated with the UE, as described above.

Process 600 may include additional aspects, such as any single aspect or any combination of aspects described below or in connection with one or more other processes described elsewhere herein.

In a first aspect, the plurality of REGs within each resource block set of the one or more resource block sets are interleaved.

In a second aspect, alone or in combination with the first aspect, the plurality of REGs within different resource block sets are non-interleaved.

In a third aspect, alone or in combination with one or more of the first and second aspects, the one or more resource block sets include fewer than the plurality of resource block sets that span the CORESET, and monitoring the set of frequency resources comprises monitoring a subset of the CORESET.

In a fourth aspect, alone or in combination with one or more of the first through third aspects, the one or more control channel candidates associated with the UE are contained within the one or more resource block sets.

In a fifth aspect, alone or in combination with one or more of the first through fourth aspects, the one or more resource block sets include the plurality of resource block sets that span the CORESET, and monitoring the set of frequency resources comprises monitoring frequency resources that span the CORESET.

In a sixth aspect, alone or in combination with one or more of the first through fifth aspects, the plurality of resource block sets are interleaved within the CORESET according to a first equation associated with a geometric interleaving or a second equation associated with a non-geometric interleaving.

In a seventh aspect, alone or in combination with one or more of the first through sixth aspects, process 600 includes receiving, from a network node, signaling configuring a mapping of the plurality of resource block sets to the CORESET, wherein the plurality of resource block sets are interleaved within the CORESET based at least in part on the mapping.

In an eighth aspect, alone or in combination with one or more of the first through seventh aspects, the plurality of resource block sets are interleaved within the CORESET according to a resource block set granularity, and the resource block set granularity corresponds to a number of resource block sets.

In a ninth aspect, alone or in combination with one or more of the first through eighth aspects, process 600 includes receiving, from a network node, signaling indicating the resource block set granularity.

In a tenth aspect, alone or in combination with one or more of the first through ninth aspects, a configuration for an interleaving of the plurality of resource block sets within the CORESET is based at least in part on a configuration of the CORESET, a type of the CORESET, an aggregation level associated with the one or more control channel candidates associated with the UE, or a second set of frequency resources corresponding to the CORESET.

In an eleventh aspect, alone or in combination with one or more of the first through tenth aspects, process 600 includes transmitting signaling indicating a bandwidth that the UE is capable of monitoring, wherein the bandwidth has a granularity corresponding to a resource block set.

In a twelfth aspect, alone or in combination with one or more of the first through eleventh aspects, the signaling indicates the bandwidth based at least in part on including an indication of a number of resource block sets corresponding to the bandwidth.

In a thirteenth aspect, alone or in combination with one or more of the first through twelfth aspects, process 600 includes receiving, from a network node, signaling indicating the set of frequency resources that the UE is to monitor, wherein the signaling indicates the set of frequency resources based at least in part on including an indication of the one or more resource block sets.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with interleaving control resources.

As shown in FIG. 7, in some aspects, process 700 may include identifying a plurality of resource block sets that span a CORESET and that are interleaved within the CORESET, wherein each resource block set of the plurality of resource block sets includes a plurality of REGs (block 710). For example, the network node (e.g., using communication manager 906, depicted in FIG. 9) may identify a plurality of resource block sets that span a CORESET and that are interleaved within the CORESET, wherein each resource block set of the plurality of resource block sets includes a plurality of REGs, as described above.

As further shown in FIG. 7, in some aspects, process 700 may include mapping one or more control channel candidates to the plurality of resource block sets based at least in part on an interleaving of the plurality of resource block sets within the CORESET (block 720). For example, the network node (e.g., using communication manager 906, depicted in FIG. 9) may map one or more control channel candidates to the plurality of resource block sets based at least in part on an interleaving of the plurality of resource block sets within the CORESET, as described above.

As further shown in FIG. 7, in some aspects, process 700 may include transmitting the one or more control channel candidates via the CORESET (block 730). For example, the network node (e.g., using transmission component 904 or communication manager 906, depicted in FIG. 9) may transmit the one or more control channel candidates via the CORESET, as described above.

Process 700 may include additional aspects, such as any single aspect or any combination of aspects described below or in connection with one or more other processes described elsewhere herein.

In a first aspect, process 700 includes interleaving the plurality of REGs within each resource block set, wherein the CORESET includes the plurality of resource block sets that are interleaved and each of the plurality of resource block sets include a plurality of REGs that are interleaved.

In a second aspect, alone or in combination with the first aspect, the plurality of REGs within different resource block sets are non-interleaved.

In a third aspect, alone or in combination with one or more of the first and second aspects, the interleaving of the plurality of resource block sets is indicated by a first equation associated with a geometric interleaving or a second equation associated with a non-geometric interleaving.

In a fourth aspect, alone or in combination with one or more of the first through third aspects, process 700 includes transmitting, to a UE, signaling configuring a mapping of the plurality of resource block sets to the CORESET, wherein the interleaving of the plurality of resource block sets is based at least in part on the mapping.

In a fifth aspect, alone or in combination with one or more of the first through fourth aspects, the interleaving of the plurality of resource block sets interleaves the plurality of resource block sets according to a resource block set granularity, and the resource block set granularity corresponds to a number of resource block sets.

In a sixth aspect, alone or in combination with one or more of the first through fifth aspects, process 700 includes transmitting, to a UE, signaling indicating the resource block set granularity.

In a seventh aspect, alone or in combination with one or more of the first through sixth aspects, a configuration for the interleaving is based at least in part on a configuration of the CORESET, a type of the CORESET, an aggregation level associated with the one or more control channel candidates, or a set of frequency resources corresponding to the CORESET.

In an eighth aspect, alone or in combination with one or more of the first through seventh aspects, process 700 includes receiving, from a UE, signaling indicating a bandwidth that the UE is capable of monitoring, wherein the bandwidth has a granularity corresponding to a resource block set.

In a ninth aspect, alone or in combination with one or more of the first through eighth aspects, the signaling indicates the bandwidth based at least in part on comprising an indication of a number of resource block sets corresponding to the bandwidth.

In a tenth aspect, alone or in combination with one or more of the first through ninth aspects, process 700 includes transmitting, to a UE, signaling indicating a set of frequency resources that the UE is to monitor to detect control channel candidates associated with the UE, wherein the signaling indicates the set of frequency resources based at least in part on including an indication of the one or more resource block sets.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 3-5. Additionally, or alternatively, the apparatus 800 may be configured to perform one or more processes described herein, such as process 600 of FIG. 6, process 700 of FIG. 7, or a combination thereof. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The communication manager 806 may identify, from a plurality of resource block sets that span CORESET and that are interleaved within the control resource set, one or more resource block sets that include one or more control channel candidates associated with the UE, wherein each resource block set of the plurality of resource block sets includes a plurality of REGs. The communication manager 806 may identify a set of frequency resources associated with the one or more resource block sets. The communication manager 806 may monitor the set of frequency resources for the one or more control channel candidates associated with the UE.

The reception component 802 may receive, from a network node, signaling configuring a mapping of the plurality of resource block sets to the CORESET, wherein the interleaving of the plurality of resource block sets is based at least in part on the mapping.

The reception component 802 may receive, from a network node, signaling indicating the resource block set granularity.

The transmission component 804 may transmit signaling indicating a bandwidth that the UE is capable of monitoring, wherein the bandwidth has a granularity corresponding to a resource block set.

The reception component 802 may receive, from a network node, signaling indicating the set of frequency resources that the UE is to monitor, wherein the signaling indicates the set of frequency resources based at least in part on including an indication of the one or more resource block sets.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 3-5. Additionally, or alternatively, the apparatus 900 may be configured to perform one or more processes described herein, such as process 600 of FIG. 6, process 700 of FIG. 7, or a combination thereof. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The communication manager 906 may identify a plurality of resource block sets that span a CORESET and that are interleaved within the CORESET, wherein each resource block set of the plurality of resource block sets comprises a plurality of REGs. The communication manager 906 may map one or more control channel candidates to the plurality of resource block sets based at least in part on an interleaving of the plurality of resource block sets within the CORESET. The transmission component 904 may transmit the one or more control channel candidates via the CORESET.

The communication manager 906 may interleave the plurality of REGs within each resource block set, wherein the CORESET comprises the plurality of resource block sets that are interleaved and each of the plurality of resource block sets comprise a plurality of REGs that are interleaved.

The transmission component 904 may transmit, to a UE, signaling configuring a mapping of the plurality of resource block sets to the CORESET, wherein the interleaving of the plurality of resource block sets is based at least in part on the mapping.

The transmission component 904 may transmit, to a UE, signaling indicating the resource block set granularity.

The reception component 902 may receive, from a UE, signaling indicating a bandwidth that the UE is capable of monitoring, wherein the bandwidth has a granularity corresponding to a resource block set.

The transmission component 904 may transmit, to a UE, signaling indicating a set of frequency resources that the UE is to monitor to detect control channel candidates associated with the UE, wherein the signaling indicates the set of frequency resources based at least in part on including an indication of the one or more resource block sets.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: identifying, from a plurality of resource block sets that span CORESET and that are interleaved within the control resource set, one or more resource block sets that include one or more control channel candidates associated with the UE, wherein each resource block set of the plurality of resource block sets includes a plurality of REGs; identifying a set of frequency resources associated with the one or more resource block sets; and monitoring the set of frequency resources for the one or more control channel candidates associated with the UE.

Aspect 2: The method of Aspect 1, wherein the plurality of REGs within each resource block set of the one or more resource block sets are interleaved.

Aspect 3: The method of Aspect 1, wherein the plurality of REGs within different resource block sets are non-interleaved.

Aspect 4: The method of any of Aspects 1-3, wherein: the one or more resource block sets include fewer than the plurality of resource block sets that span the CORESET; and monitoring the set of frequency resources comprises monitoring a subset of the CORESET.

Aspect 5: The method of Aspect 4, wherein the one or more control channel candidates associated with the UE are contained within the one or more resource block sets.

Aspect 6: The method of any of Aspects 1-4, wherein: the one or more resource block sets include the plurality of resource block sets that span the CORESET; and monitoring the set of frequency resources comprises monitoring frequency resources that span the CORESET.

Aspect 7: The method of any of Aspects 1-6, wherein the plurality of resource block sets are interleaved within the CORESET according to a first equation associated with a geometric interleaving or a second equation associated with a non-geometric interleaving.

Aspect 8: The method of any of Aspects 1-7, further comprising: receiving, from a network node, signaling configuring a mapping of the plurality of resource block sets to the CORESET, wherein the plurality of resource block sets are interleaved within the CORESET based at least in part on the mapping.

Aspect 9: The method of any of Aspects 1-8, wherein: the plurality of resource block sets are interleaved within the CORESET according to a resource block set granularity; and the resource block set granularity corresponds to a number of resource block sets.

Aspect 10: The method of Aspect 9, further comprising: receiving, from a network node, signaling indicating the resource block set granularity.

Aspect 11: The method of any of Aspects 1-10, wherein a configuration for an interleaving of the plurality of resource block sets within the CORESET is based at least in part on a configuration of the CORESET, a type of the CORESET, an aggregation level associated with the one or more control channel candidates associated with the UE, or a second set of frequency resources corresponding to the CORESET.

Aspect 12: The method of any of Aspects 1-11, further comprising: transmitting signaling indicating a bandwidth that the UE is capable of monitoring, wherein the bandwidth has a granularity corresponding to a resource block set.

Aspect 13: The method of Aspect 12, wherein the signaling indicates the bandwidth based at least in part on including an indication of a number of resource block sets corresponding to the bandwidth.

Aspect 14: The method of any of Aspects 1-13, further comprising: receiving, from a network node, signaling indicating the set of frequency resources that the UE is to monitor, wherein the signaling indicates the set of frequency resources based at least in part on including an indication of the one or more resource block sets.

Aspect 15: A method of wireless communication performed by a network node, comprising: identifying a plurality of resource block sets that span a CORESET and that are interleaved within the CORESET, wherein each resource block set of the plurality of resource block sets includes a plurality of REGs; mapping one or more control channel candidates to the plurality of resource block sets based at least in part on an interleaving of the plurality of resource block sets within the CORESET; and transmitting the one or more control channel candidates via the CORESET.

Aspect 16: The method of Aspect 15, further comprising: interleaving the plurality of REGs within each resource block set, wherein the CORESET includes the plurality of resource block sets that are interleaved and each of the plurality of resource block sets include a plurality of REGs that are interleaved.

Aspect 17: The method of Aspect 15, wherein the plurality of REGs within different resource block sets are non-interleaved.

Aspect 18: The method of any of Aspects 15-17, wherein the interleaving of the plurality of resource block sets is indicated by a first equation associated with a geometric interleaving or a second equation associated with a non-geometric interleaving.

Aspect 19: The method of any of Aspects 15-18, further comprising: transmitting, to a UE, signaling configuring a mapping of the plurality of resource block sets to the CORESET, wherein the interleaving of the plurality of resource block sets is based at least in part on the mapping.

Aspect 20: The method of any of Aspects 15-19, wherein: the interleaving of the plurality of resource block sets interleaves the plurality of resource block sets according to a resource block set granularity; and the resource block set granularity corresponds to a number of resource block sets.

Aspect 21: The method of Aspect 20, further comprising: transmitting, to a UE, signaling indicating the resource block set granularity.

Aspect 22: The method of any of Aspects 15-21, wherein a configuration for the interleaving is based at least in part on a configuration of the CORESET, a type of the CORESET, an aggregation level associated with the one or more control channel candidates, or a set of frequency resources corresponding to the CORESET.

Aspect 23: The method of any of Aspects 15-22, further comprising: receiving, from a UE, signaling indicating a bandwidth that the UE is capable of monitoring, wherein the bandwidth has a granularity corresponding to a resource block set.

Aspect 24: The method of Aspect 23, wherein the signaling indicates the bandwidth based at least in part on including an indication of a number of resource block sets corresponding to the bandwidth.

Aspect 25: The method of any of Aspects 15-24, further comprising: transmitting, to a UE, signaling indicating a set of frequency resources that the UE is to monitor to detect control channel candidates associated with the UE, wherein the signaling indicates the set of frequency resources based at least in part on including an indication of the one or more resource block sets.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

Aspect 33: A device comprising a processing system that includes one or more processors and one or more code-storing memories coupled with the one or more processors, the processing system configured to cause the device to perform the method of one or more of Aspects 1-25.

Aspect 34: A device comprising a processing system that includes processor circuitry and code-storing memory circuitry, the processing system configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
identify, from a plurality of resource block sets that span a control resource set and that are interleaved within the control resource set, one or more resource block sets that include one or more control channel candidates associated with the UE, wherein each resource block set of the plurality of resource block sets includes a plurality of resource element groups;
identify a set of frequency resources associated with the one or more resource block sets; and
monitor the set of frequency resources for the one or more control channel candidates associated with the UE.

2. The UE of claim 1, wherein the plurality of resource element groups within each resource block set of the one or more resource block sets are interleaved.

3. The UE of claim 1, wherein the plurality of resource element groups within different resource block sets are non-interleaved.

4. The UE of claim 1, wherein:
the one or more resource block sets include fewer than the plurality of resource block sets that span the control resource set; and
monitoring the set of frequency resources comprises monitoring a subset of the control resource set.

5. The UE of claim 4, wherein the one or more control channel candidates associated with the UE are contained within the one or more resource block sets.

6. The UE of claim 1, wherein:
the one or more resource block sets include the plurality of resource block sets that span the control resource set; and
monitoring the set of frequency resources comprises monitoring frequency resources that span the control resource set.

7. The UE of claim 1, wherein the plurality of resource block sets are interleaved within the control resource set according to a first equation associated with a geometric interleaving or a second equation associated with a non-geometric interleaving.

8. The UE of claim 1, wherein the processing system is configured to cause the UE to:
receive, from a network node, signaling configuring a mapping of the plurality of resource block sets to the control resource set, wherein the plurality of resource block sets are interleaved within the control resource set based at least in part on the mapping.

9. The UE of claim 1, wherein:
the plurality of resource block sets are interleaved within the control resource set according to a resource block set granularity; and
the resource block set granularity corresponds to a number of resource block sets.

10. The UE of claim 9, wherein the processing system is configured to cause the UE to:
receive, from a network node, signaling indicating the resource block set granularity.

11. The UE of claim 1, wherein a configuration for an interleaving of the plurality of resource block sets within the control resource is based at least in part on a configuration of the control resource set, a type of the control resource set, an aggregation level associated with the one or more control channel candidates associated with the UE, or a second set of frequency resources corresponding to the control resource set.

12. The UE of claim 1, wherein the processing system is configured to cause the UE to: transmit signaling indicating a bandwidth that the UE is capable of monitoring, wherein the bandwidth has a granularity corresponding to a resource block set.

13. The UE of claim 12, wherein the signaling indicates the bandwidth based at least in part on including an indication of a number of resource block sets corresponding to the bandwidth.

14. The UE of claim 1, wherein the processing system is configured to cause the UE to:
receive, from a network node, signaling indicating the set of frequency resources that the UE is to monitor, wherein the signaling indicates the set of frequency resources based at least in part on including an indication of the one or more resource block sets.

15. A method of wireless communication performed by a user equipment (UE), comprising:
identifying, from a plurality of resource block sets that span a control resource set and that are interleaved within the control resource set, one or more resource block sets that include one or more control channel candidates associated with the UE, wherein each resource block set of the plurality of resource block sets includes a plurality of resource element groups;
identifying a set of frequency resources associated with the one or more resource block sets; and
monitoring the set of frequency resources for the one or more control channel candidates associated with the UE.

16. The method of claim 15, wherein the plurality of resource element groups within each resource block set of the one or more resource block sets are interleaved.

17. The method of claim 15, wherein the plurality of resource element groups within different resource block sets are non-interleaved.

18. The method of claim 15, wherein:
the one or more resource block sets include fewer than the plurality of resource block sets that span the control resource set; and
monitoring the set of frequency resources comprises monitoring a subset of the control resource set.

19. The method of claim 18, wherein the one or more control channel candidates associated with the UE are contained within the one or more resource block sets.

20. The method of claim 15, wherein:
the one or more resource block sets include the plurality of resource block sets that span the control resource set; and
monitoring the set of frequency resources includes monitoring frequency resources that span the control resource set.

21. The method of claim 15, wherein the plurality of resource block sets are interleaved within the control resource set according to a first equation associated with a geometric interleaving or a second equation associated with a non-geometric interleaving.

22. The method of claim 15, further comprising:
receiving, from a network node, signaling configuring a mapping of the plurality of resource block sets to the control resource set, wherein the plurality of resource block sets are interleaved within the control resource set based at least in part on the mapping.

23. The method of claim 15, wherein:
the plurality of resource block sets are interleaved within the control resource set according to a resource block set granularity; and
the resource block set granularity corresponds to a number of resource block sets.

24. The method of claim 23, further comprising:
receiving, from a network node, signaling indicating the resource block set granularity.

25. The method of claim 15, wherein a configuration for an interleaving of the plurality of resource block sets within the control resource is based at least in part on a configuration of the control resource set, a type of the control resource set, an aggregation level associated with the one or more control channel candidates associated with the UE, or a second set of frequency resources corresponding to the control resource set.

26. The method of claim 15, further comprising:
transmitting signaling indicating a bandwidth that the UE is capable of monitoring, wherein the bandwidth has a granularity corresponding to a resource block set.

27. The method of claim 26, wherein the signaling indicates the bandwidth based at least in part on including an indication of a number of resource block sets corresponding to the bandwidth.

28. The method of claim 15, further comprising:
receiving, from a network node, signaling indicating the set of frequency resources that the UE is to monitor, wherein the signaling indicates the set of frequency resources based at least in part on including an indication of the one or more resource block sets.

29. A non-transitory computer-readable medium storing a set of instructions for wireless communication, the set of instructions comprising:
one or more instructions that, when executed by one or more processors of a user equipment (UE), cause the UE to:
identify, from a plurality of resource block sets that span a control resource set and that are interleaved within the control resource set, one or more resource block sets that include one or more control channel candidates associated with the UE, wherein each resource block set of the plurality of resource block sets includes a plurality of resource element groups;
identify a set of frequency resources associated with the one or more resource block sets; and
monitor the set of frequency resources for the one or more control channel candidates associated with the UE.

30. An apparatus for wireless communication, comprising:
means for identifying, from a plurality of resource block sets that span a control resource set and that are interleaved within the control resource set, one or more resource block sets that include one or more control channel candidates associated with the apparatus, wherein each resource block set of the plurality of resource block sets includes a plurality of resource element groups;
means for identifying a set of frequency resources associated with the one or more resource block sets; and
means for monitoring the set of frequency resources for the one or more control channel candidates associated with the apparatus.
